(19) United States
(12) Patent Application Publication
(10) Pub. No.: US 2004/0126470 A1
(43) Pub. Date: Jul. 1, 2004

(54) Apparatus and method for obtaining intact fresh grains from fresh grainy fruits, in particular pomegranate

(76) Inventor: Moshe Harpaz, South Golan Hights (IL)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/724,785

(22) Filed: Dec. 1, 2003

(30) Foreign Application Priority Data
Jan. 1, 2003 (IL) 153774

(51) Int. Cl. A23P 1/00

(52) U.S. Cl. 426/484

(57) ABSTRACT

It is an object of the invention to present a disassembling method and apparatus for easy and low-cost disassembling of fresh grainy fruits, (incl. vegetable) in particular pomegranate, without harming the grains.

The method is based on sending vibrations in the appropriate resonance frequency into a tank full of conductive liquid in which the fresh grainy fruits are placed. The fresh grainy fruits are disassembled, the heavy grains sink and are been directed to a collecting tank whereas the floating skin is removed through a separate container.

### FIELD AND BACKGROUND OF INVENTION

Todate the known methods for disassembling fresh grainy fruits are the following:

By cutting open the fresh fruit and using thin air pressure or water jets.

By cutting open the fresh fruit and mechanically beating the outer shell.

By cutting open the fresh fruit and mechanically shaking the fruit.

Opening the fresh fruit by hand and disassembling the grains manually.

The disadvantage of all the above methods is, the damaging of the fresh grains when the fresh fruit is cut open, it needs expensive manpower and it is not useful for mass production.

The method introduced hereinafter is a low-cost method suitable both, for mass production and for domestic use.

### SUMMARY OF THE INVENTION

The method is based on sending vibrations in the appropriate resonance frequency into a container full of conductive liquid in which the fresh grainy fruits are placed. Once the grains are affected by the resonance they detach from the fruit and leave the liquid separated.

The method is put into function by using an apparatus consisting of the following parts: an engine (1) placed on a surface-bridge (6) located on top of liquid container (8), a pitman (3) which on one side is connected to engine (1) and on the other side to arm (7) which is connected to paddle (10) that is submerged in the liquid (9).

Engine (1) provides vibrations in a desired resonance frequency. The resonance, which is controlled by height of wave resulting from ex-center's (2) deviation from center of axis (1a) and length of wave resulting from engine's rotation speed, is transferred to liquid container via pitman (3). Pitman (3) changes the rotary motion through arm (7) into reciprocating movement of paddle (10) that creates the appropriate waves in the liquid (9).

The deviation of ex-center from center of axis (1a) and the length of wave resulting from engine's rotation speed affects the desired resonance frequency. When the fresh fruit receives the vibrations in the appropriate resonance frequency the fruit is disassembled, the heavy grains sink and are been directed to a collecting tank, whereas the floating skin is removed to separate container.

### SHORT DESCRIPTION OF DRAWING

FIG. 1 shows a block diagram of an apparatus, which gives a general idea of the method. The apparatus is composed of the following parts: engine (1), ex-center (2), axis (1a), pitman (3), bearings (4) & (5), a surface-bridge (6), arm (7), container (8), conductive liquid (9) and paddle (10).

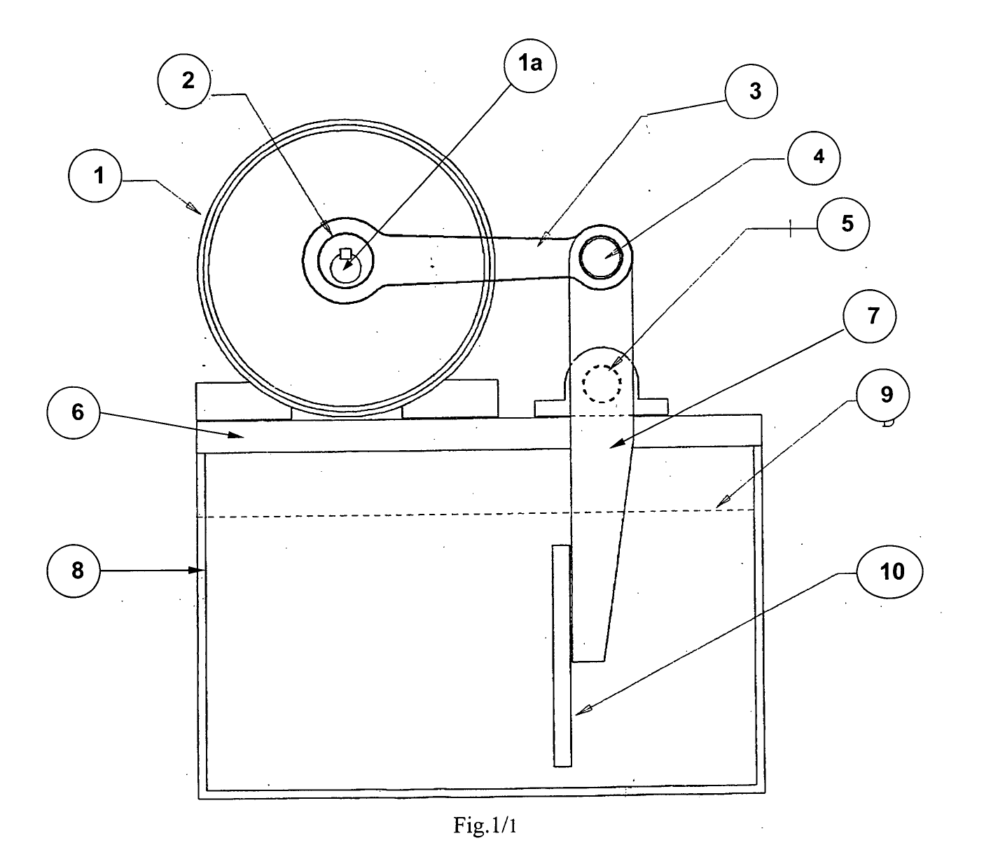

Engine (1) is placed on surface-bridge (6) that is located on top of liquid container (8). The pitman (3) is secured by bearing (4) to arm (7) on one side and to axis (1a) of engine (1) on the other side. Arm (7) is secured to pitman by bearing (4) and to surface-bridge (6) by bearing (5) and at its lower part it is connected to paddle (10), which is submerged in container (8) containing conductive liquid (9).

### DETAILED DESCRIPTION OF THE INVENTION

The invention introduced hereunder includes an apparatus for easy and low-cost disassembling of fresh grainy fruits, (incl. vegetable) in particular pomegranate, without harming the fresh grains. The apparatus consists of the following parts: a sliding ramp, an engine (1) placed on a surface-bridge (6) covering a liquid container (8), a pitman (3) which on one side is connected to engine (1) and on the other side to arm (7) and a paddle (10), which is submerged in conductive liquid (9) placed in container (8). Engine (1) of min. capacity 2HP provides vibrations in a desired resonance frequency, which is controlled by height of wave resulting from ex-center's (2) deviation from center of axis (1a) and length of wave resulting from engine's rotation speed. The desired resonance frequency is transferred to conductive liquid in container (8) via pitman (3). Pitman (3) changes the rotary motion of paddle (10) through arm (7) into reciprocating movement of paddle (10).

The deviation of ex-center from center of axis (1a) and the length of wave resulting from engine's rotation speed affects the desired resonance frequency. When the appropriate resonance frequency reaches the conductive liquid it affects the fresh fruit in the liquid and causes it to disassemble. The unharmed heavy grains sink and are collected and directed to a collecting tank whereas the floating skin is disposed of through a separate container.

I claim:

1. a disassembling method and apparatus for disassembling fresh grainy fruits without harming the grains, based on using vibrations in appropriate resonance frequency in a tank full of conductive liquid in which the fresh grainy fruits are placed, said resonance frequency causes the grains to be detached from fruit into intact grains and skin, wherein the apparatus comprises
an engine of min. capacity 2HP placed on a surface-bridge located on top of a container with conductive liquid,
a pitman that is secured by a bearing to an arm on one side and to the axis of the engine on the other side,
the ex-center is attached to the center of the axis of the engine in a certain deviation which affects the resonance frequency received, and said deviation varies according to the required resonance frequency for different kinds of fresh grainy fruits to be disassembled according to its frequency tolerance.
the arm is secured to the pitman and to surface-bridge by bearings whereas its lower part is connected to a paddle that is submerged in a container with conductive liquid.

2. an engine of min. capacity 2HP according to claim 1, wherein capacity of engine varies according to nature and quantity of fresh fruits to be disassembled whereas the desired resonance frequency vibrations are controlled by height of wave resulting from ex-center's deviation from center of axis and length of wave resulting from engine's rotation speed.

3. a pitman is secured by a bearing to an arm on one side and to the axis of the engine on the other side according to claim 1 and when receiving vibrations from engine the vibrations are transferred to liquid either by changing rotary motion of paddle into reciprocating movement of paddle or by any other method.

4. the ex-center is attached to the axis of the engine in a calculated deviation from center of axis according to claim 2, the deviation of ex-center from center of axis affects the length of wave resulting from engine's rotation speed thus affects the desired resonance frequency.

5. a paddle submerged in conductive liquid connected to the arm according to claim 1 and when receiving vibrations from arm causes reciprocating movement in liquid that disassemble the grainy fruits.

6. the transfer of desired resonance frequency from engine to liquid for the detachment of the grains from the fruit can be by various methods beside the shaking of the paddle, like shaking of container or any other part thereof that is in contact with liquid.
